(19) United States
(12) Patent Application Publication
(10) Pub. No.: US 2025/0197273 A1
(43) Pub. Date: Jun. 19, 2025

(54) HOLLOW-CORE OPTICAL FIBERS

(71) Applicant: CORNING INCORPORATED, CORNING, NY (US)

(72) Inventors: Matthew Ryan Drake, Big Flats, NY (US); Sushmit Sunil Kumar Goyal, Painted Post, NY (US); Dan Trung Nguyen, Painted Post, NY (US); Shivam Sahu, Horseheads, NY (US); Pushkar Tandon, Painted Post, NY (US); Matthew Artus Tuggle, Seattle, WA (US)

(21) Appl. No.: 18/968,080

(22) Filed: Dec. 4, 2024

Related U.S. Application Data
(60) Provisional application No. 63/611,361, filed on Dec. 18, 2023.

(51) Int. Cl. C03B 37/027

(52) U.S. Cl. CPC C03B 37/02781; C03B 2203/16

(57) ABSTRACT

The present disclosure is directed to various embodiments and methods for producing a hollow-core optical fiber. The methods may include heating a hollow-core preform having a cross-sectional area greater than 0.0013 m². The hollow-core preform may include a substrate with an inner surface. The interior cavity may include a tube in contact with the inner surface. The method may also include drawing the hollow-core optical fiber from the hollow-core preform. The drawing may include elongating the tube to a capillary which may include a contact length with the inner surface of the substrate. The contact length may be a linear distance from a first contact point of the capillary with the inner surface of the substrate to a second contact point of the capillary with the inner surface of the substrate. The contact length may be less than or equal to 20% of a capillary outer diameter.

This application claims the benefit of priority to U.S. Provisional Patent Application Ser. No. 63/611,361 filed on Dec. 18, 2023, the content of which is relied upon and incorporated herein by reference in its entirety.

### FIELD

The present specification generally relates to methods for producing optical fibers, and more specifically, to methods for producing hollow-core optical fibers and hollow-core optical fibers produced therefrom.

### TECHNICAL BACKGROUND

Hollow-core optical fibers have the unique ability to guide light through the air structure (i.e., the hollow core) centralized along the long axis of the fiber. This leads to the realization of lower loss optical fibers than solid-core optical fibers (i.e., optical fibers having a core of solid silica-based glass) at various wavelengths, and significantly lower latency due to the light guiding in air (refractive index of air˜1, versus 1.444 for silica at 1550 nm). In addition, hollow-core optical fibers offer advantages with respect to ultralow non-linearities, flat dispersion, broadband transmission, and lower attenuation. As such, hollow-core optical fibers are attractive for use in a variety of applications.

The attenuation mechanisms in hollow-core optical fibers are different from the attenuation mechanisms encountered in solid-core optical fibers, with the loss dominated by confinement losses, surface scattering, and microbending, which result in inefficiencies. Various designs for hollow-core optical fibers have been proposed to reduce attenuation due to each of these mechanisms, including non-touching nested capillary designs.

Currently, however, it is difficult to manufacture hollow-core optical fibers in large volume and/or with low manufacturing cost due to various issues encountered in the fabrication process, especially when manufacturing long lengths of hollow-core optical fibers at appreciable draw speeds from large preforms. In that regard, existing techniques are only capable of draw lengths on the order of 7 km from small preforms and draw speeds of less than 0.50 m/s.

Accordingly, a need exists for alternative methods for manufacturing hollow-core optical fibers with relatively low confinement losses and hollow-core optical fibers manufactured therefrom.

### SUMMARY

According to a first aspect of the present disclosure, a method for producing a hollow-core optical fiber comprises heating a hollow-core preform having a cross-sectional area greater than 0.0013 m², the hollow-core preform comprising a substrate structure with an inner surface defining an interior cavity, the interior cavity comprising a tube in contact with the inner surface of the substrate structure, the tube comprising a wall defining an internal opening; and drawing the hollow-core optical fiber from the hollow-core preform, the drawing comprising elongating the tube to a capillary and elongating the substrate structure to a substrate, the capillary comprising a capillary outer diameter and a contact length with the inner surface of the substrate, wherein: the contact length is a linear distance from a first contact point of the capillary with the inner surface of the substrate to a second contact point of the capillary with the inner surface of the substrate; and the contact length is less than or equal to 20% of the capillary outer diameter.

A second aspect of the present disclosure may include the first aspect, wherein the cross-sectional area of the hollow-core preform is greater than 0.002 m².

A third aspect of the present disclosure may include the first aspect or the second aspect, wherein the contact length with the inner surface of the substrate is less than or equal to 5% of the capillary outer diameter.

A fourth aspect of the present disclosure may include any of the first through third aspects, wherein the tube comprises a nested tube and the nested tube is in contact with an interior surface of the wall of the tube.

A fifth aspect of the present disclosure may include the fourth aspect, wherein the drawing further comprises elongating the nested tube to a nested capillary, the nested capillary comprising a nested capillary outer diameter and a nested contact length with the inner surface of the substrate.

A sixth aspect of the present disclosure may include the fifth aspect, wherein: the nested contact length is a linear distance from a third contact point of the nested capillary with the inner surface of the substrate to a fourth contact point of the nested capillary with the inner surface of the substrate; and the nested contact length is less than or equal to 20% of the nested capillary outer diameter.

A seventh aspect of the present disclosure may include any of the first through sixth aspects, wherein the heating further comprises passing the hollow-core preform through a draw furnace, the draw furnace having a maximum draw furnace temperature of less than 2,000° C.

An eighth aspect of the present disclosure may include the seventh aspect, wherein the draw furnace comprises a draw furnace length of less than or equal to 20 cm.

A ninth aspect of the present disclosure may include any of the first through eighth aspects, further comprising drawing the hollow-core optical fiber from the hollow-core preform at a draw speed of greater than or equal to 1.00 m/s.

A tenth aspect of the present disclosure may include any of the first through ninth aspects, further comprising flowing gas through at least one of the interior cavity, the internal opening, or both the interior cavity and the internal opening.

According to an eleventh aspect of the present disclosure, a method of producing a hollow-core optical fiber comprises heating a hollow-core preform having a cross-sectional area greater than 0.0013 m², the hollow-core preform comprising a substrate structure with an inner surface defining an interior cavity, the interior cavity comprising a tube in contact with the inner surface of the substrate structure, the tube comprising a wall defining an internal opening; and drawing the hollow-core optical fiber from the hollow-core preform, the drawing comprising elongating the tube to a capillary and elongating the substrate structure to a substrate, the capillary comprising a capillary outer diameter and a contact length with the inner surface of the substrate, wherein the drawing decreases a core diameter of a hollow core of the hollow-core optical fiber, wherein: a core distance from the inner surface of the interior cavity to the core diameter of the hollow core is greater than or equal to 90% of the capillary outer diameter; the contact length is a linear distance from a first contact point of the capillary with the inner surface of the substrate to a second contact point of the capillary with the inner surface of the substrate; and the contact length is less than or equal to 20% of the capillary outer diameter.

A twelfth aspect of the present disclosure may include the eleventh aspect, wherein the core distance is greater than or equal to 93% of the capillary outer diameter.

A thirteenth aspect of the current disclosure may include either of the eleventh aspect or twelfth aspect, wherein the tube comprises a nested tube in contact with an interior surface of the wall of the tube.

A fourteenth aspect of the present disclosure may include the thirteenth aspect, wherein the drawing further comprises elongating the nested tube to a nested capillary, the nested capillary comprising a nested capillary outer diameter and a nested contact length with the inner surface of the substrate.

A fifteenth aspect of the present disclosure may include the fourteenth aspect, wherein: the nested contact length is a linear distance from a third contact point of the nested capillary with the inner surface of the substrate to a fourth contact point of the nested capillary with the inner surface of the substrate; and the nested contact length is less than or equal to 20% of the nested capillary outer diameter.

A sixteenth aspect of the present disclosure may include the fifteenth aspect, wherein the core distance is from the nested capillary outer diameter to the core diameter of the hollow core.

According to a seventeenth aspect of the present disclosure, a method of producing a hollow-core optical fiber comprises heating a hollow-core preform having a cross-sectional area greater than 0.0013 m², the hollow-core preform comprising a substrate structure with an inner surface defining an interior cavity, the interior cavity comprising a tube in contact with the inner surface of the substrate structure, the tube comprising a wall defining an internal opening; flowing gas through at least one of the interior cavity, the internal opening, or both the interior cavity and the internal opening; and drawing the hollow-core optical fiber from the hollow-core preform at a draw temperature, the drawing comprising elongating the tube to a capillary and elongating the substrate structure to a substrate, the capillary comprising a capillary outer diameter and a contact length with the inner surface of the substrate, wherein: the contact length is a linear distance from a first contact point of the capillary with the inner surface of the substrate to a second contact point of the capillary with the inner surface of the substrate; the contact length is less than or equal to 20% of the capillary outer diameter; and the drawing of the hollow-core optical fiber satisfies the following Equation 1:

$${X}_{1} = \frac{{L}_{draw} σ}{{V}_{draw} 2 μ {r}_{cap}} \qquad EQU . 1$$

wherein L_{draw} is a draw furnace length, σ is a surface tension of the substrate at the draw temperature, V_{draw} is a draw speed of the hollow-core optical fiber, μ is a viscosity of the substrate at the draw temperature, and r_{cap} is a capillary radius of the capillary, wherein X₁ is less than or equal to 0.015.

An eighteenth aspect of the present disclosure may include the seventeenth aspect, wherein X₁ is less than or equal to 0.013.

A nineteenth aspect of the present disclosure may include either of the seventeenth aspect or the eighteenth aspect, wherein X₁ is less than or equal to 0.010.

A twentieth aspect of the present disclosure may include any of the seventeenth through nineteenth aspects, wherein drawing of the hollow-core optical fiber satisfies the following Equation 2:

$${X}_{2} = \frac{{L}_{draw} Δ p}{{V}_{draw} μ} \qquad EQU . 2$$

wherein Δp is a pressure differential between the capillary and a hollow core of the hollow-core optical fiber during the drawing, wherein X₂ is greater than or equal to 10⁻⁷.

A twenty-first aspect of the present disclosure may include the twentieth aspect, wherein X₂ is greater than or equal to 10⁻⁶.

A twenty-second aspect of the present disclosure may include either of the twentieth aspect or the twenty-first aspect, wherein X₂ is greater than or equal to 10⁻⁵.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A schematically depicts a cross-sectional view of a hollow-core preform, according to one or more embodiments described herein;

FIG. 1B schematically depicts a cross-sectional view of a hollow-core optical fiber drawn from a hollow-core preform, according to one or more embodiments described herein;

FIG. 2A schematically depicts a cross-sectional view of capillaries of a hollow-core optical fiber drawn from a hollow-core preform, according to one or more embodiments described herein;

FIG. 2B schematically depicts a contact length of a capillary, according to one or more embodiments described herein;

FIG. 3A schematically depicts a cross-sectional view of a hollow-core preform, according to one or more embodiments described herein;

FIG. 3B schematically depicts a cross-sectional view of a nested tube of a hollow-core preform, according to one or more embodiments described herein;

FIG. 3C schematically depicts a cross-sectional view of a hollow-core optical fiber drawn from a hollow-core preform, according to one or more embodiments described herein;

FIG. 3D schematically depicts a cross-sectional view of a nested capillary of a hollow-core optical fiber drawn from a hollow-core preform, according to one or more embodiments described herein;

FIG. 4A schematically depicts a cross-sectional view of nested capillaries of a hollow-core optical fiber drawn from a hollow-core preform, according to one or more embodiments described herein;

FIG. 4B schematically depicts a contact length of a nested capillary, according to one or more embodiments described herein;

FIG. 5 schematically depicts a draw production system, according to one or more embodiments described herein;

FIG. 6A schematically depicts capillaries drawn from a hollow-core preform of a first cross-sectional area, according to one or more embodiments described herein;

FIG. 6B schematically depicts capillaries drawn from a hollow-core preform of a second cross-sectional area, according to one or more embodiments described herein;

FIG. 6C schematically depicts capillaries drawn from a hollow-core preform of a third cross-sectional area, according to one or more embodiments described herein;

FIG. 7A schematically depicts capillaries drawn from a hollow-core preform heated at a first furnace temperature, according to one or more embodiments described herein;

FIG. 7B schematically depicts capillaries drawn from a hollow-core preform heated at a second furnace temperature, according to one or more embodiments described herein;

FIG. 7C schematically depicts capillaries drawn from a hollow-core preform heated at a third furnace temperature, according to one or more embodiments described herein;

FIG. 8A schematically depicts capillaries drawn from a hollow-core preform at a first draw speed, according to one or more embodiments described herein;

FIG. 8B schematically depicts capillaries drawn from a hollow-core preform at a second draw speed, according to one or more embodiments described herein; and

FIG. 8C schematically depicts capillaries drawn from a hollow-core preform at a third draw speed, according to one or more embodiments described herein.

### DETAILED DESCRIPTION

Reference will now be made in detail to various embodiments of hollow-core optical fibers. Whenever possible, the same reference numerals will be used throughout the drawings to refer to the same or like parts. In embodiments, methods for producing a hollow-core optical fiber may comprise heating a hollow-core preform having a cross-sectional area greater than 0.0013 m². The hollow-core preform may comprise a substrate with an inner surface defining an interior cavity and the interior cavity may comprise a tube in contact with the inner surface of the substrate. The tube may comprise a wall defining an internal opening. The method may further comprise drawing the hollow-core optical fiber from the hollow-core preform. The drawing may comprise elongating the tube to a capillary and the capillary may comprise a capillary outer diameter and a contact length with the inner surface of the substrate. The contact length may be a linear distance from a first contact point of the capillary with the inner surface of the substrate to a second contact point of the capillary with the inner surface of the substrate and the contact length may be less than or equal to 2% of the capillary outer diameter. Various embodiments of methods for producing hollow-core optical fiber, and hollow-core optical fibers produced therefrom, will be described herein with specific reference to the appended drawings.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Various components described herein may be referred to as “directly connected” or “indirectly connected.” Components are directly connected when they are joined to one another with no intervening structure. Components may be joined by fusing, melting, welding, soldering, adhesives, or any other suitable attachment means. Components are “indirectly connected” when they are joined to one another with intervening structure. Examples of intervening structure include welding aids (e.g. frits, solders, fluxes), adhesives, and bonding materials. In embodiments, components connected indirectly are connected only by a welding aid, adhesive, or bonding material. The term “connected” means “directly connected” or “indirectly connected.” Components “directly connected” to one another are said to be in direct contact with each other. Components “indirectly connected” to one another are said to be in indirect contact with each other. Components “connected” to one another are in direct or indirect contact with each other.

As used herein, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used herein, the term “linear” refers to relative distances/lengths between points. A “linear” distance/length may refer to a distance between two points along a straight line.

As used herein, the singular forms “a,” “an” and “the” include plural referents in addition to the single referent unless the context clearly dictates otherwise. Thus, for example, reference to “a” component includes aspects having one such component as well as two or more such components, unless the context clearly indicates otherwise.

Hollow-core optical fibers may be produced by drawing a hollow-core preform into fiber. Hollow-core optical fibers may include capillaries as cladding elements or cladding elements that include capillaries. The capillaries confine light to the hollow core of the fiber, resulting in more efficient optical fibers. The capillaries are formed from tubes in the hollow-core preform from which the hollow-core optical fiber is drawn. In conventional hollow-core preforms, the tubes are in contact with an inner surface of the substrate structure (i.e., the tubes are in contact with the inner surface of a substrate structure of the preform) and centered about a hollow cavity of the preform that extends along the centerline of the preform. During heating of the hollow-core preform, the tubes may soften and flow into the inner surface of the substrate structure, or otherwise deform, resulting in hollow-core optical fibers with higher confinement losses due to deformation of the capillaries during production. In particular, the deformation of the tubes may affect the amount of contact between the capillaries and the inner surface of the substrate of the hollow-core optical fiber, which may reduce the effectiveness of capillaries as cladding elements confining light to the hollow core of the hollow-core optical fiber, increasing confinement losses and decreasing the efficiency of propagating optical signals in the hollow core of the fiber.

To prevent an increase in the contact area between the capillaries and the inner surface of the substrate, methods have been proposed to utilize preforms with smaller cross-sectional areas. This reduces the amount of time or temperature required to heat the preform, resulting in less deformation of the tubes from which the capillaries are formed. However, utilizing preforms with small cross-sectional areas result in shorter draw lengths of hollow-core optical fibers (i.e., shorter optical fibers).

Methods for producing hollow-core optical fibers described herein utilize preforms with large cross-sectional areas, while still minimizing deformation of the tubes of the preform during draw of the preform to form hollow-core optical fibers. In particular, the methods disclosed herein include controlling manufacturing parameters to minimize the contact length between the capillaries that form from the tubes and the inner surface of the substrate of the hollow-core optical fiber that forms from the support structure of the preform. Parameters controlled in this method may include, but are not limited to furnace temperature, furnace length, draw speed, capillary pressure, the pressure applied to the hollow core, the pressure differential between the capillary and hollow core, capillary radius, core distance, surface tension of the substrate, and/or viscosity of the substrate.

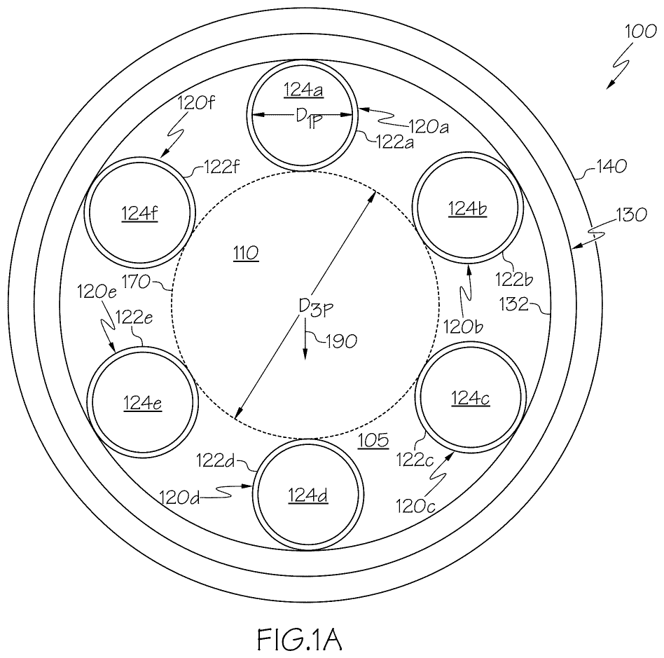

Methods for producing a hollow-core optical fiber include drawing the hollow-core optical fiber from a hollow-core preform. Referring now to FIG. 1A, the hollow-core preform 100 may comprise a substrate structure 130 with an inner surface 132 defining an interior cavity 105. In embodiments, the substrate structure 130 may be, for example and without limitation, a hollow glass tube, such as a hollow glass tube formed from silica glass or silica-based glass (i.e., silica glass comprising one or more dopants which increase or decrease the index of refraction of the silica glass). The interior cavity 105 includes a hollow section 110 and tubes 120 in contact with the inner surface 132 of the substrate structure 130. Hollow section 110 is the central portion of interior cavity 105 and corresponds to the hollow core region of a hollow-core optical fiber 200 drawn from hollow-core preform 100 (as explained further herein). Tubes 120 are in contact with the inner surface 132 of the substrate structure 130. Tubes 120 may be formed from silica glass or silica-based glass (i.e., silica glass comprising one or more dopants which increase or decrease the index of refraction of the silica glass). In the embodiment depicted in FIG. 1A, tube 120a is in direct contact with the inner surface 132 of the substrate structure 130. It should be noted that the embodiment of the hollow-core preform 100 depicted in FIG. 1A includes six tubes, 120a, 120b, 120c, 120d, 120c, and 120f, which may be referred to generally as tube 120 or collectively as tubes 120. It should also be noted that similar notation is used for other repeated structures appearing in the figures of the present disclosure.

In embodiments, the hollow-core preform 100 may comprise two or more tubes 120. For example, without limitation, the hollow-core preform 100 may comprise two or more, three or more, four or more, five or more, or even six or more tubes 120. In embodiments, each tube 120 may be directly connected to inner surface 132 of the substrate structure 130. For example, without limitation, each tube 120 may be fused to the inner surface 132 of the substrate structure 130 during production of the hollow-core preform 100. In embodiments, each tube comprises a wall 122 (i.e., walls 122a, 122b, 122c, 122d, 122e, and 122f) defining an internal opening 124 (i.e., internal openings 124a, 124b, 124c, 124d, 124e, and 124f). The tubes 120 may be evenly spaced along the inner surface 132 of the substrate structure 130. For example, the center-to-center between each tube 120 may be equidistant, as depicted in FIG. 1A.

In embodiments, the hollow-core preform 100 may optionally comprise an overclad 140. The overclad 140 is in contact with an outer surface of the substrate structure 130. In an embodiment, the overclad 140 is in direct contact with an outer surface of the substrate structure 130. In such embodiments, the substrate structure 130 may be positioned between the overclad 140 and the interior cavity 105. In embodiments, the overclad 140 may comprise a hollow glass tube formed from silica glass or silica-based glass (i.e., silica glass comprising one or more dopants which increase or decrease the index of refraction of the silica glass). While FIG. 1A schematically depicts the hollow-core preform 100 as comprising the overclad 140, it should be understood that the overclad 140 is optional and that, in some embodiments, the hollow-core preform 100 is formed without the overclad 140.

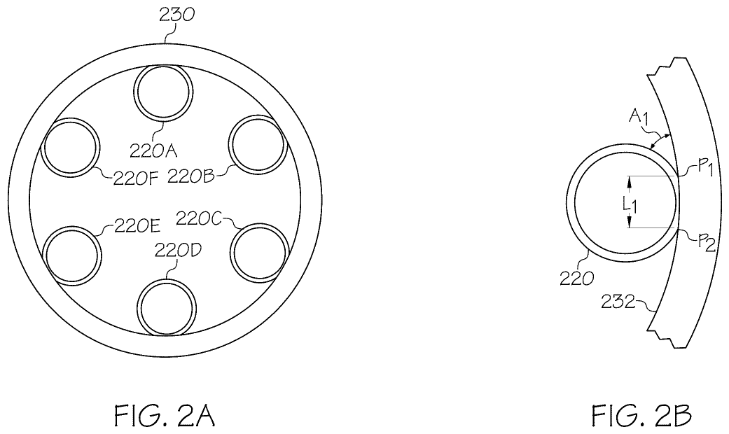

Referring now to FIG. 3A, in embodiments, at least one tube 120 in the hollow-core preform 100 may comprise a nested tube 150. As described herein, a “nested tube” refers to a tube positioned within another tube such that an exterior surface of the nested tube is connected to an interior surface of the other tube. In embodiments, the nested tube 150 may directly contact an interior surface 126 of the wall 122 of the tube 120. For example, in the embodiment depicted in FIG. 3A, nested tube 150a is in direct contact with an interior surface 126a of the wall 122a of tube 120a. In embodiments, each tube 120 in the hollow-core preform 100 may comprise a nested tube 150 (i.e, nested tubes 150a, 150b, 150c, 150d, 150c, and 150f in the embodiment depicted in FIG. 3A), and the nested tubes 150 may include internal openings 154 (i.e., internal openings 154a, 154b, 154c, 154d, 154c, and 154f in the embodiment depicted in FIG. 3A). The nested tubes 150 may be formed from silica glass or silica-based glass (i.e., silica glass comprising one or more dopants which increase or decrease the index of refraction of the silica glass).

In embodiments, the nested tubes 150 may be directly or indirectly connected to the interior surface 126 of the wall 122 of the tube 120 at a point proximate to the inner surface 132 of the substrate structure 130. As described herein, a point may be proximate to the substrate structure 130 when it is the closest point to the substrate structure 130 evaluated in a radial direction 190. In embodiments, a nested tube 150 may be directly or indirectly connected to the interior surface 126 of the wall 122 of the tube 120 at a point that is within 30° of the point proximate to where the tube 120 is connected to the substrate structure 130 (as measured from the center of the tube 120), as depicted in FIG. 3B. For example, without limitation, a nested tube 150 may be directly or indirectly connected to the interior surface 126 of the wall 122 of the tube 120 at a point that is within 30°, 25°, 20°, 15°, 10°, 5°, or even 1° of the point proximate to the substrate structure 130.

In embodiments described herein, the hollow-core preform 100 of FIG. 1A or 3A may be drawn into a hollow-core optical fiber 200 as depicted in FIG. 1B or 3C. As noted further herein, hollow-core optical fiber 200 drawn from a hollow-core preform may include capillaries 220 or nested capillaries 250 formed from the tubes 120 and nested tubes 150, respectively, and as depicted in FIGS. 1B and 3C. The hollow-core optical fiber 200 can be described as a scaled down version of the hollow-core preform 100 when the hollow-core preform 100 is heated and drawn as described herein.

Referring now to FIG. 1B, a cross-section of a hollow-core optical fiber 200 is depicted. The hollow-core optical fiber 200 can be formed, for example, by drawing the hollow-core preform 100 depicted in FIG. 1A. The hollow-core optical fiber 200 may comprise a substrate 230 with an inner surface 232 defining an interior space 205. The interior space 205 includes hollow core 210 and capillaries 220. The hollow core 210 is the central portion of interior space 205 and corresponds to the region of hollow-core optical fiber 200 in which optical signals are primarily confined and propagate. Capillaries 220 are cladding elements of the hollow-core optical fiber 200 positioned around the hollow core 210 of the hollow-core optical fiber 200. Capillaries 220 are in contact with the inner surface 232 of the substrate 230 and spaced apart from one another in the circumferential direction. In the embodiment depicted in FIG. 1B, capillaries 220 are in direct contact with the inner surface 232 of the substrate 230. It should be noted that the embodiment of the hollow-core optical fiber 200 depicted in FIG. 1B includes six capillaries, 220a, 220b, 220c, 220d, 220c, and 220f, which may be referred to generally as capillary 220 or collectively as capillaries 220. Capillaries 220 are formed from corresponding tubes 120 of the hollow-core preform 100 during the draw process (e.g., capillary 220a is formed from tube 120a, etc.). Hollow core 210 is formed from the hollow section 110 of the hollow-core preform 100. As hollow-core preform 100 is drawn, tubes 120 thin and decrease in diameter to form capillaries 220 of the hollow-core optical fiber 200. A corresponding thinning and decrease in the diameter of the substrate structure 130 occurs during drawing to form the substrate 230 of the hollow-core optical fiber 200. Corresponding contraction of the diameter of the hollow section 110 occurs during drawing to form the hollow core 210 of the hollow-core optical fiber 200.

In embodiments, the hollow-core optical fiber 200 may comprise two or more capillaries 220. For example, without limitation, the hollow-core optical fiber 200 may comprise two or more, three or more, four or more, five or more, or even six or more capillaries 220. In embodiments, each capillary 220 may be in direct contact with inner surface 232 of the substrate 230.

In embodiments, each capillary 220 comprises a wall 222 (i.e., wall 222a, 222b, 222c, 222d, 222e, and 222f) defining an internal opening 224 (i.e., internal openings 224a, 224b, 224c, 224d, 224c, and 224f). As noted above with respect to the tubes 120, each capillary 220 may be evenly spaced along the inner surface 232 of the substrate 230. Spacing between adjacent capillaries 220 may be equal. For example, the center-to-center between each capillary 220 may be equidistant, as depicted in FIG. 1B. The capillary 220 may include a capillary outer diameter D_{4F}.

In embodiments, the hollow-core optical fiber 200 may optionally comprise an overclad 240 formed from the overclad 140 of hollow-core preform 100. The overclad 240 is in contact with an outer surface of the substrate 230. In an embodiment, the overclad 240 is in direct contact with an outer surface of the substrate 230. In such embodiments, the substrate 230 is positioned between the overclad 240 and the hollow core 210.

Referring now to FIG. 3C, another embodiment of a hollow-core optical fiber 201 is shown. Hollow-core optical fiber 201 can be formed, for example, by drawing the hollow-core preform 100 shown in FIG. 3A. In embodiments, at least one capillary 220 in the hollow-core optical fiber 201 may comprise a nested capillary 250. As described herein, a “nested capillary” refers to a capillary positioned within another capillary such that an exterior surface of the nested capillary is connected to an interior surface of the other capillary. In embodiments, the nested capillary 250 may directly contact an interior surface 226 of the wall 222 of the capillary 220. For example, in the embodiment depicted in FIG. 3C, nested capillary 250a is in direct contact with an interior surface 226a of the wall 222a of capillary 220a. In embodiments, each capillary 220 in the hollow-core optical fiber 201 may comprise a nested capillary 250 (i.e., nested capillaries 250a, 250b, 250c, 250d, 250c, and 250f in the embodiment depicted in FIG. 3C). The nested capillary 250 may include a nested capillary outer diameter D_{5F}.

In embodiments, the nested capillaries 250 may be directly or indirectly connected to the interior surface 226 of the wall 222 of the capillary 220 at a point proximate to the inner surface of the substrate 230. As described herein, a point may be proximate to the substrate 230 when it is the closest point to the substrate 230 evaluated in the radial direction 190. In embodiments, a nested capillary 250 may be directly or indirectly connected to the interior surface 226 of the wall 222 of the capillary 220 at a point that is within 30° of the point proximate to where the capillary 220 is connected to the substrate 230 as measured from the center of the capillary 220, as depicted in FIG. 3D. For example, without limitation, a nested capillary 250 may be directly or indirectly connected to the interior surface 226 of the wall 222 of the capillary 220 at a point that is within 30°, 25°, 20°, 15°, 10°, 5°, or even 1° of the point proximate to the substrate 230.

Referring again to FIGS. 1A and 1B, in embodiments, drawing the hollow-core preform 100 decreases an inner diameter D_{1P} of the internal opening 124 of one or more of the tubes 120 to form capillaries 220 with inner diameter D_{1F} and outer diameter D_{4F}. In particular, without limitation, drawing the hollow-core preform 100 may decrease an inner diameter D_{1P} of the internal opening 124 of one or more of the tubes 120 to an inner diameter D_{1F} when forming capillaries 220. In embodiments, drawing the hollow-core preform 100 may decrease the inner diameter D_{1P} of the internal opening 124 of each tube 120 to form a plurality of capillaries 220 with the inner diameter D_{1F}. The inner diameter D_{1F} is, for example, without limitation, from 12μ m to 50 μm, from 16 μm to 50 μm, from 20 μm to 50 μm, from 24 μm to 50 μm, from 28μ m to 50 μm, from 32 μm to 50 μm, from 36 μm to 50 μm, from 40 μm to 50 μm, from 44 μm to 50 μm, from 48 μm to 50 μm, from 12 μm to 46 μm, 12 μm to 42 μm, from 12 μm to 38 μm, from 12 μm to 34 μm, from 12 μm to 30 μm, from 12 μm to 26 μm, from 12 μm to 22 μm, from 12 μm to 18 μm, from 12 μm to 16 μm, or any combination or sub-set of these ranges

In embodiments, a capillary radius r_{cap} may be used in determining other parameters of the drawing process (as discussed further herein). The capillary radius r_{cap} may be one-half of the inner diameter D_{1F} depicted in FIG. 1B of the internal opening 224 of the capillaries 220. In embodiments, each capillary may have the same inner diameter D_{1F}. In embodiments, such as the embodiment depicted in FIG. 3A, drawing the hollow-core preform 100 varies an inner diameter D_{2P} of one or more of the nested tubes 150 to form nested capillaries 250 having an inner diameter D_{2F} and the nested capillary outer diameter D_{5F}. For example, without limitation, drawing the hollow-core preform 100 may decrease the inner diameter D_{2P} of one or more of the nested tubes 150, or even each of the nested tubes 150, to form nested capillaries 250 with inner diameter D_{2F}.

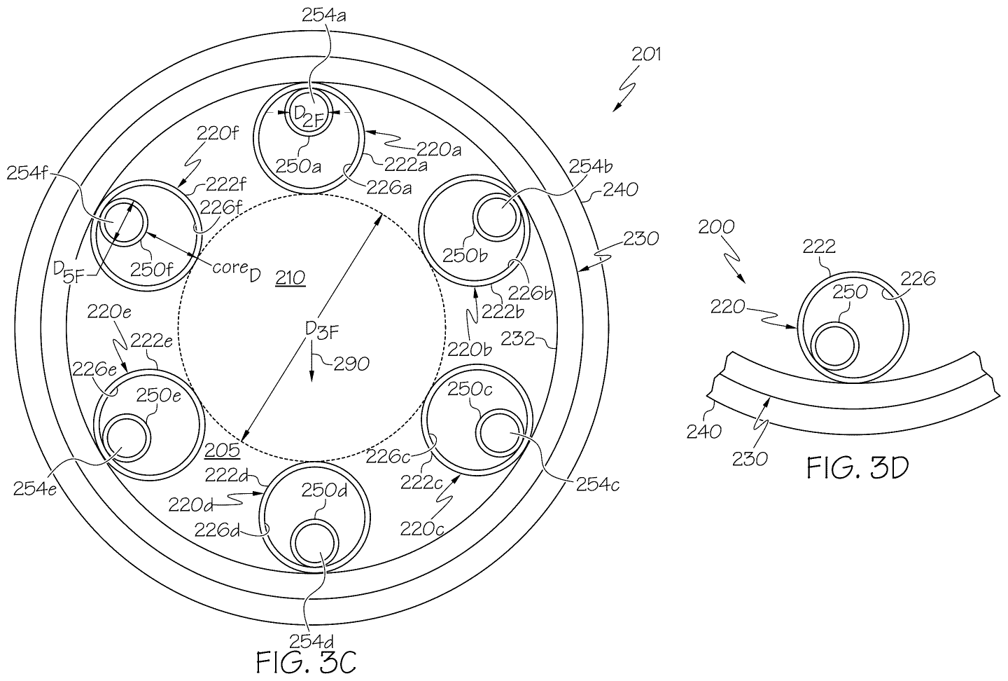

As noted hereinabove, the hollow-core optical fiber 200 and hollow-core optical fiber 201 are produced through utilization of the draw production system 1100 as depicted in FIG. 5. The draw production system 1100 may include a manifold 1120 connected to a gas supply 1122 for supplying gas to the hollow-core preform 100 and hollow-core optical fiber 200. Downstream of the manifold 1120, the draw production system 1100 may also include a draw furnace 1102 for heating the hollow-core preform 100 and a cooling tube 1112 for cooling the hollow-core optical fiber 200. The draw production system 1100 may also include a tractor 1106 for applying tension to the hollow-core optical fiber 200.

In embodiments, the hollow-core preform 100 may have a draw end. As described herein, the “draw end” of the hollow-core preform 100 is the end of the preform from which optical fiber is drawn during the drawing process. Before the hollow-core preform 100 is drawn into optical fiber, methods for producing hollow-core optical fiber described herein may include heating the hollow-core preform 100 by advancing the hollow-core preform 100 into the draw furnace 1102 that is heated to an elevated temperature (e.g., greater than 1000° C.). The hollow-core preform 100 is disposed vertically in the draw furnace 1102 such that the draw end of the hollow core preform faces downward (i.e., in the direction of gravity) and the draw furnace 1102 supplies heat to the hollow-core preform 100. The draw end of the hollow-core preform 100 may enter the draw furnace 1102 first. In embodiments, the draw furnace may have a draw furnace length L_{draw} of less than or equal to 30 cm. In other embodiments, the draw furnace may have a draw furnace length L_{draw} of less than or equal to 25 cm, less than or equal to 20 cm, less than or equal to 15 cm, less than or equal to 12 cm, less than or equal to 10 cm, or even less than or equal to 5 cm.

As noted herein, the draw production system 1100 comprises a manifold 1120 attached to the hollow-core preform 100. The manifold 1120 may be attached to the end of the hollow-core preform that is opposite the draw end of the hollow-core preform 100. The manifold 1120 may be fluidly connected to the gas supply 1122, and the manifold 1120 may be operable to supply gas to the interior cavity 105 of hollow-core preform 100. The flow of gas from gas supply 1122 to the hollow-core preform 100 via manifold 1120 may be controlled to regulate the pressure of the hollow core of the hollow-core preform 100 during the drawing process. The gas supply 1122 may consists or consist essentially of air. In other embodiments, the gas supply 1122 consists of or consists essentially of an inert gas. As described herein, an inert gas refers to any gas that is non-reactive during the drawing process. Inert gasses may include, but are not limited to, nitrogen, argon, and helium.

Referring to FIGS. 1A, 3A, and 5, in embodiments, the manifold 1120 may be further connected to the tubes 120 of the hollow-core preform 100 and/or the nested tubes 150 of the hollow-core preform 100. In such embodiments, the manifold 1120 may include valves to regulate the pressure of the gas supplied to the interior cavity 105 of the hollow-core preform 100, the tubes 120 of the hollow-core preform 100, and/or the nested tubes 150 of the hollow-core preform 100. In such embodiments, the manifold 1120 may be controlled to separately regulate the pressure within the interior cavity 105, the tubes 120, and/or the nested tubes 150 of the hollow-core preform 100. Regulation of the pressure within the interior cavity 105, the tubes 120, and/or the nested tubes 150 of the hollow-core preform 100 may be utilized to achieve a desired pressure differential between the interior cavity 105, the tubes 120, and/or the nested tubes 150 of the hollow-core preform 100 as hollow-core optical fiber is drawn from the hollow-core preform 100. The flow of gas from the gas supply 1122 to the hollow-core preform 100 may be controlled by any suitable means. For example, without limitation, the flow rate of gas from the gas supply to the hollow-core preform 100 may be controlled manually or by an automated control system.

For example, without limitation, the manifold 1120 may be formed of glass and may be welded to the hollow-core preform 100. In such embodiments, the manifold 1120 may include individual channels corresponding to the interior cavity 105, the tubes 120, and the nested tubes 150 of the hollow-core preform 100 and gas supply lines may couple each individual channel of the manifold 1120 to the gas supply 1122. As such, it should be understood that the manifold 1120 may be individually attached to the interior cavity 105 and each of the tubes 120 or the nested tubes 150. Valves (not depicted) may be disposed along the supply lines to regulate the pressure of the gas flowing through each supply line. As such, the flow of gas into the interior cavity 105, each of the tubes 120, and each of the nested tubes 150 may be independently regulated, allowing for separate and independent regulation of pressure within the interior cavity 105, each of the tubes 120, and each of the nested tubes 150.

As such, drawing the hollow-core preform 100 may also include regulating a pressure of the interior cavity 105, a pressure of the internal opening 124 of the tubes 120, or the internal opening 154 of the nested tubes 150 to a desired pressure differential between different portions of the hollow-core preform 100 (i.e., between the tubes 120, the nested tubes 150, and/or the interior cavity 105). In embodiments, the pressure may be constant or may be varied over time during the draw. Without intending to be bound by theory, the pressure differential may be a pressure that prevents the collapse or deformation of tubes 120 and/or the nested tubes 150 during the drawing process. For example, during the drawing process, the pressure in the tubes 120 and/or the nested tubes 150 may be greater than the pressure in the interior cavity 105, to prevent collapse of the capillaries 220 (FIGS. 1B and 3C) and/or the nested capillaries 250 (FIG. 3C) of the hollow-core optical fiber. Adjusting the difference in pressure between the tubes 120, nested tubes 150, and/or the interior cavity 105 may allow the inner diameter D_{1P} of the internal opening 124 of the tubes 120, the inner diameter D_{2P} of the nested tubes 150, and the core diameter D_{3P} of the hollow section 110 of the hollow-core preform 100 to be controlled. In embodiments, the pressure of the interior cavity 105, the internal opening 124 of the tubes 120, and the internal opening 154 of the nested tubes 150 may be regulated by flowing gas through at least one of the interior cavity 105, the internal opening 124 of the tubes 120, or the internal opening 154 of the nested tubes 150.

In embodiments, the pressure differential between the interior cavity 105 and the internal openings 124 of the tubes 120 may be adjusted from zero, such as when other draw parameters (discussed in further detail herein) are adjusted and the pressure differential is adjusted to account for changes in the draw parameters. The pressure differential between the interior cavity 105 and the internal openings 124 of the tubes 120 may also be adjusted when the inner diameter D_{1F} of the internal opening 224 of the capillaries 220 is to be adjusted when compared to the inner diameter D_{1F} of the internal opening 224 of the capillaries 220 when no pressure differential is applied. Moreover, the pressure differential between the internal openings 124 of the tubes 120 and the internal openings 154 of the nested tubes 150 may be adjusted when the inner diameter D_{2F} of the internal opening 254 of the nested capillaries 250 is to be adjusted when compared to the inner diameter D_{2F} of the internal opening 254 of the nested capillaries 250 when no pressure differential is applied.

In some embodiments, since the diameter of the internal openings of the tubes 120, the diameter of the internal openings 154 of the nested tubes 150, and the diameter of the interior cavity 105 vary, delivery of gas to the interior cavity 105 may lead to differential flow rates of gas into the tubes 120, nested tubes 150, and the interior cavity 105. Thus, even though the differential pressure between the interior cavity 105, the internal openings 124 of the tubes 120, or the internal openings 154 of the nested tubes 150 is low, the gas flow rate may be different into the interior cavity 105 (such as higher or lower) when compared to that through each of the internal openings 124 of the tubes 120 or the internal openings 154 of the nested tubes 150.

As noted herein, as the hollow-core preform 100 is heated and drawn, as in the draw production system 1100 of FIG. 5, the hollow-core optical fiber 200 is produced. As such, regulation of pressures within the hollow-core preform 100 and the hollow-core optical fiber 200 may increase or decrease the relative diameters of the capillaries 220, nested capillaries 250, or the hollow core 210. Although relative diameters of the capillaries 220 are described herein, it should be understood that pressure differentials may also be applied to the nested capillaries 250 to increase or decrease relative diameters of the nested capillaries 250.

In embodiments, regulating the pressure of the interior cavity 105 comprises increasing the pressure in the interior cavity 105. For example, a baseline pressure may be established in the interior cavity 105. Without intending to be bound by theory, increasing the pressure in the interior cavity 105 during the drawing process (relative to the baseline pressure) may assist in decreasing the inner diameter D_{1F} of the internal opening 224 of the capillaries 220 in the hollow-core optical fiber 200 (relative to the inner diameter D_{1F} at the baseline pressure). As such, the core diameter D_{3F} of the hollow core 210 may increase when compared to the core diameter D_{3F} of the hollow core 210 at baseline pressure (due to the decreasing of the inner diameter D_{1F} of the internal opening 224 of the capillaries 220 with respect to the baseline pressure).

In contrast, in some embodiments, regulating the pressure of the internal openings 124 of the tubes 120 comprises increasing the pressure in the internal openings 124 of the tubes 120. For example, a baseline pressure may be established in the internal openings 124 of the tubes 120. Without intending to be bound by theory, increasing the pressure in the internal openings 124 of the tubes 120 during the drawing process (relative to the baseline pressure) may assist in decreasing the core diameter D_{3F} of the hollow core 210 during the drawing process (relative to the core diameter D_{3F} at baseline pressure). As such, the inner diameter D_{1F} of the internal opening 224 of the capillaries 220 may increase when compared to the inner diameter D_{1F} of the internal opening 224 of the capillaries 220 at baseline pressure (due to the decreasing of the core diameter D_{3F} with respect to the baseline pressure).

Regulating the pressure of either of the interior cavity 105 of the substrate structure 130 or the internal openings 124 of the tubes 120 may also include decreasing the pressure in the interior cavity 105 or the internal openings 124. Without intending to be bound by theory, decreasing the pressure in the interior cavity 105 during the drawing process (relative to the baseline pressure) may increase the inner diameter D_{1F} of the internal openings 224 of the capillaries 220 in the hollow-core optical fiber 200 (relative to the inner diameter D_{1F} at the baseline pressure). Additionally, decreasing the pressure in the interior cavity 105 may decrease the core diameter D_{3F} of the hollow core 210 of the hollow-core optical fiber 200 (relative to the core diameter D_{3F} at baseline pressure). In contrast, decreasing the pressure in the internal openings 124 of the tubes 120 during the drawing process (relative to the baseline pressure) may decrease the inner diameter D_{1F} of the internal openings 224 of the capillaries 220 in the hollow-core optical fiber 200 (relative to the inner diameter D_{1F} at the baseline pressure). Additionally, decreasing the pressure in the internal openings 124 of the tubes 120 may increase the core diameter D_{3F} of the hollow core 210 of the hollow-core optical fiber 200 (relative to the core diameter D_{3F} at baseline pressure).

Referring again to FIGS. 1A-5, simultaneous with applying heat and pressure as described herein, the method may also include drawing the hollow-core optical fiber 200 from the hollow-core preform 100. The drawing may include elongating the tubes 120 to form capillaries 220. During the drawing, the hollow-core optical fiber 200 is drawn from a bottom portion (softened draw end) of hollow-core preform 100 by tension applied by tractor 1106. After exiting the draw furnace 1102, the hollow-core optical fiber 200 may pass through a diameter monitoring device 1108 that provides a signal used in a feedback control loop to regulate a speed and/or tension of tractor 1106 and thereby maintain a constant fiber diameter. The hollow-core optical fiber 200 may then pass through a surface tension measurement device 1110 that measures the tension of the hollow-core optical fiber 200 and provides a feedback control loop to the tractor 1106 to regulate the surface tension of hollow-core optical fiber 200 and maintain a desired surface tension setting.

Still referring to FIG. 5, once the hollow-core optical fiber 200 is drawn from hollow-core preform 100, the hollow-core optical fiber 200 is cooled in the cooling tube 1112 or other controlled cooling treatment device positioned downstream from the exit of the draw furnace 1102. Thereafter, the hollow-core optical fiber 200 is coated by coater 1114 that applies a polymeric-based coating material to the outside surface of the hollow-core optical fiber 200. The hollow-core optical fiber 200 may also pass through a curing apparatus 1116 that cures the polymeric coating (e.g., with ultraviolet light). The hollow-core optical fiber 200 is then wound onto a spool or reel 1118.

In embodiments, drawing the hollow-core preform 100 to a hollow-core optical fiber 200 decreases a core diameter D_{3P} of the hollow section 110. As described herein, the core diameter D_{3P} of the hollow section 110 is the diameter of a circle that is concentric with the substrate structure 130 and tangent to the tubes 120, depicted as circle 170 in FIGS. 1A and 3A. The region associated with core diameter D_{3P} is the hollow section 110, which defines the hollow core 210 of the hollow-core optical fiber 200 drawn from hollow-core preform 100. Circle 170 defines the boundaries of hollow section 110 of interior cavity 105. The core diameter D_{3P} is twice the radius of the hollow section 110, where the radius of the hollow section 110 is the shortest distance from the center of the hollow section 110 to the outer surface of tubes 120. In embodiments in which the inner diameter D_{1P} and wall thickness is the same for each of the tubes 120, the radius of the hollow section 110 is the same for all tubes 120. In some embodiments, small differences in D_{1P} and/or wall thickness of the tubes 120 may arise during manufacturing. In such embodiments, the radius of the hollow section 110 is taken to be the smallest of the radii to the different tubes 120; that is, the shortest of the distances from the center of hollow section 110 to a point of tangency with a tube 120.

In embodiments, drawing the hollow-core optical fiber 200 from the hollow-core preform 100 may decrease the core diameter D_{3P} of the hollow section 110 to form the core diameter D_{3F} of the hollow-core optical fiber 200. The hollow-core optical fiber 200 may also include a core distance core_{D}. The core distance core_{D} is measured from the inner surface of the interior space 205 (i.e., the inner surface of the substrate 230) to the core diameter D_{3F} of the hollow core 210, as depicted in FIG. 1B. In embodiments in which there are nested capillaries 250, the core distance core_{D} may be measured from the nested capillary outer diameter D_{5F} to the core diameter D_{3F} of the hollow core 210, as depicted in FIG. 3C. However, the core distance core_{D} may also be measured from the inner surface of the interior space 205 (i.e., the inner surface of the substrate 230) to the core diameter D_{3f} of the hollow core 210 in embodiments where the nested capillaries 250 are included.

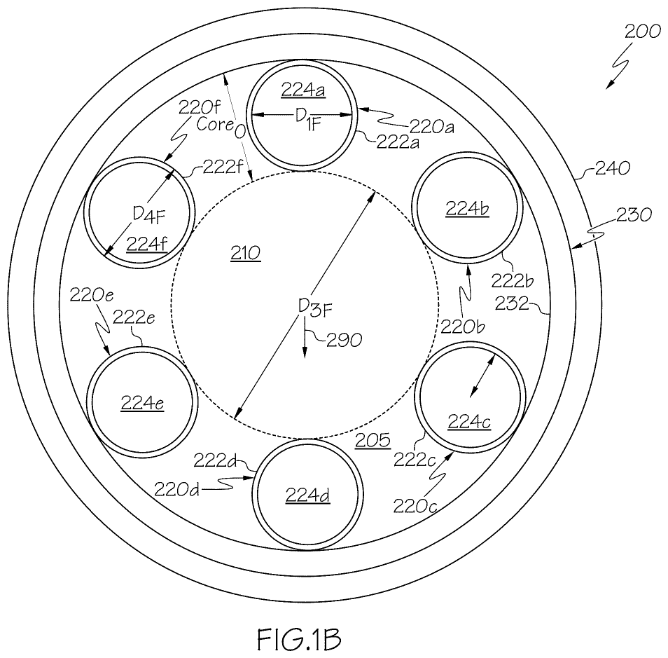

The core distance core_{D} may be different than the capillary outer diameter D_{4F}, as the capillary 220 may be melted into the inner surface 232 of the substrate 230 (as depicted in FIG. 2A and FIG. 2B). Thus, the core distance core_{D} may be as close to the capillary outer diameter D_{4F} (or as close to the difference between the capillary outer diameter D_{4F} and the nested capillary outer diameter D_{5F}) in embodiments in which there is a low contact length and, thus, low confinement losses. The light guiding mechanism of tubular anti-resonance within hollow-core optical fibers is based on inhibited coupling between the core-guided modes and cladding modes in which the coupling can be strongly inhibited by anti-resonant and negative curvature effects, such as when the core distance core_{D} is decreased.

Draw parameters may be adjusted such that the core distance core_{D} is at or near 13 microns. For example, without limitation, the core distance may be greater than or equal to 6 microns and less than or equal to 20 microns, greater than or equal to 8 microns and less than or equal to 18 microns, greater than or equal to 10 microns and less than or equal to 16 microns, greater than or equal to 12 microns and less than or equal to 14 microns, or greater than or equal to 12.5 microns and less than or equal to 13.5 microns. Draw parameters may also be adjusted to minimize a contact length L₁ of the capillaries 220, such as to reduce confinement loss within the hollow-core optical fiber 200. The core distance core_{D} may also be defined in terms of a percentage of the capillary outer diameter D_{4F}, such that the core distance core_{D} is greater than or equal to 70% of the capillary outer diameter D_{4F}, greater than or equal to 75% of the capillary outer diameter D_{4F}, greater than or equal to 80% of the capillary outer diameter D_{4F}, greater than or equal to 85% of the capillary outer diameter D_{4F}, greater than or equal to 90% of the capillary outer diameter D_{4F}, greater than or equal to 93% of the capillary outer diameter D_{4F}, greater than or equal to 95% of the capillary outer diameter D_{4f}, greater than or equal to 97% of the capillary outer diameter D_{4F}, or greater than or equal to 99% of the capillary outer diameter D_{4F}.

Minimizing the contact length L₁ of the capillaries 220 with the substrate 230, as depicted in FIG. 2A and FIG. 2B, results in lower confinement loss in the resultant hollow-core optical fiber 200. Confinement loss is directly related to the contact length L₁; the longer the contact length L₁ the greater the confinement loss. FIG. 2A shows an example depicting the contact length L₁ of the capillaries 220. FIG. 2B depicts the contact length L₁ of a single capillary 220.

In embodiments described herein, contact length L₁ is defined as a linear distance from a first contact point P₁ of the capillary 220 with the inner surface 232 of the substrate 230 to a second contact point P₂ of the capillary 220 with the inner surface 232 of the substrate 230.

Generally, the contact length L₁ varies due to the heating of the hollow-core preform 100, such that the tubes 120 are heated, softened, and deformed into the substrate structure 130. As noted herein, hollow-core preforms 100 with smaller cross-sectional areas or higher draw speeds may be utilized to minimize the amount of heat required to form the hollow-core optical fiber 200 and thus minimize the contact length L₁. However, decreasing the cross-sectional area of the hollow-core preform 100 results in shorter draw lengths (i.e., shorter optical fibers). This may result in longer production times and higher production costs, as preforms with small cross-sectional areas may have to be replaced more often than those with large cross-sectional areas. Thus, embodiments described herein are directed to controlling the draw parameters to minimize the contact length L₁, while still utilizing preforms with large cross-sectional areas.

Hollow-core preforms with cross-sectional areas of greater than 0.0013 m² may be utilized with the methods described herein, while still maintaining a short contact length L and, thus, low confinement loss within the hollow-core optical fiber 200. The cross-sectional area of the hollow-core preform 100 may be measured as an area within the inner surface 132 of the substrate structure 130, as depicted in FIG. 1A or FIG. 3A.

Hollow-core preforms used with the methods disclosed herein may have various cross-sectional areas, such as greater than or equal to 0.0001 m², greater than or equal to 0.0005 m², greater than or equal to 0.0010 m², greater than or equal to 0.0015 m², greater than or equal to 0.0020 m², greater than or equal to 0.0025 m², greater than or equal to 0.0030 m², greater than or equal to 0.0040 m², or any cross-sectional area therebetween.

As noted herein, a relatively short contact length L₁ between the substrate 230 of the hollow-core optical fiber 200 and the capillaries 220 may decrease confinement losses. In embodiments, the contact length L₁ may be less than or equal to 0.5% of the capillary outer diameter D_{4F} to improve confinement losses with the hollow-core optical fiber 200 In other embodiments, the contact length L₁ may be less than or equal to 1% of the capillary outer diameter DAF, less than or equal to 1.5% of the capillary outer diameter D_{4F}, less than or equal to 2% of the capillary outer diameter D_{4F}, less than or equal to 3% of the capillary outer diameter D_{4F}, less than or equal to 5% of the capillary outer diameter D_{4F}, less than or equal to 7% of the capillary outer diameter D_{4F}, less than or equal to 10% of the capillary outer diameter D_{4F}, less than or equal to 15% of the capillary outer diameter D_{4F}, less than or equal to 20% of the capillary outer diameter DAF, less than or equal to 25% of the capillary outer diameter D_{4F}, or less than or equal to 30% of the capillary outer diameter D_{4F}.

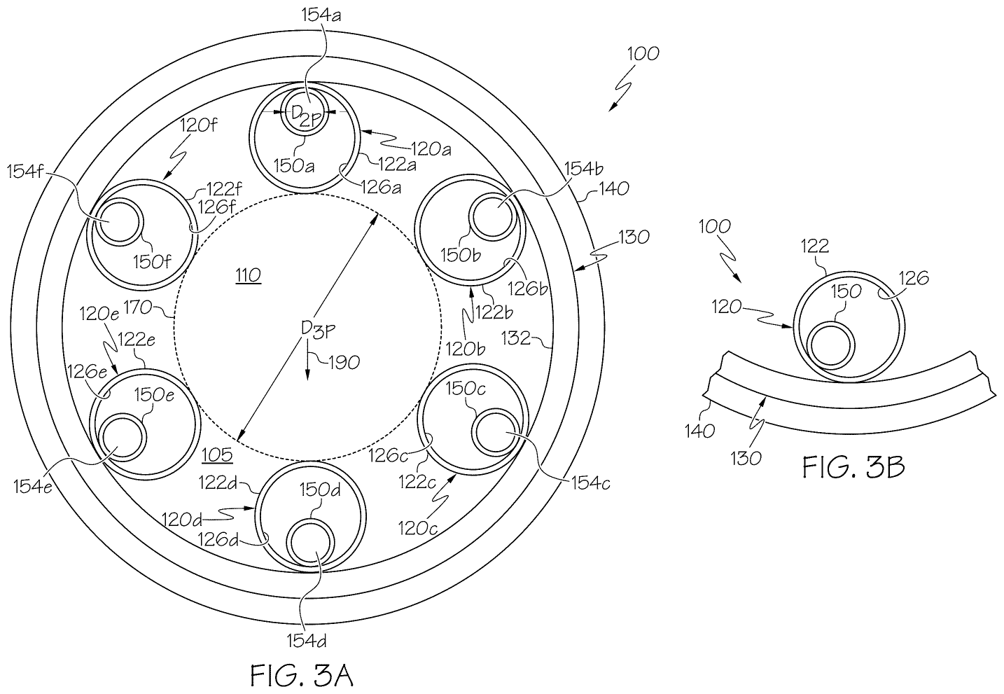

When the nested tubes 150 are included in the hollow-core preform 100, as depicted in FIG. 3A, the nested capillaries 250 may also have a nested contact length L₂ on the substrate 230, as depicted in FIG. 4B. Just as decreasing the contact length L₁ of the capillaries 220 decreases confinement losses, decreasing the nested contact length L₂ of the nested capillaries 250 also decreases confinement losses. Nested capillaries 250 indirectly contact inner surface 232 of substrate 230 through capillaries 220 at third contact point P3 and fourth contact point P4. The nested contact length L₂ may be a linear distance from a third contact point P3 of the nested capillary 250 with the inner surface 232 of the substrate 230 to a fourth contact point P4 of the nested capillary 250 with the inner surface 232 of the substrate 230. The nested contact length L₂ may be less than or equal to 0.5% of the nested capillary outer diameter D_{5F}. In other embodiments, the nested contact length L₂ may be less than or equal to 1% of the nested capillary outer diameter D_{5F}, less than or equal to 1.5% of the nested capillary outer diameter D_{5F}, less than or equal to 2% of the nested capillary outer diameter D_{5F}, less than or equal to 3% of the nested capillary outer diameter D_{5F}, less than or equal to 5% of the nested capillary outer diameter D_{5F}, less than or equal to 7% of the nested capillary outer diameter D_{5F}, less than or equal to 10% of the nested capillary outer diameter D_{5F}, less than or equal to 15% of the nested capillary outer diameter D_{5F}, less than or equal to 20% of the nested capillary outer diameter D_{5F}, less than or equal to 25% of the nested capillary outer diameter D_{5F}, or less than or equal to 30% of the nested capillary outer diameter D_{5F}.

The contact length L₁ or the contact length L₂ may be measured utilizing image analysis techniques on high magnification images of the drawn hollow-core optical fiber 200 or hollow-core optical fiber 201. As an example, images of the cross-section of the drawn hollow-core optical fiber 200 utilized for image analysis may be optical images or images from scanning electron microscopy (SEM).

Using the draw production system 1100 and the methods described herein, the contact length L₁ of the capillaries 220 or the contact length L₂ of the nested capillaries 250 may be minimized to reduce confinement losses in the hollow-core optical fiber 200. The contact lengths L₁ and L₂ may be minimized through adjusting draw parameters of the draw production system 1100 when drawing the hollow-core optical fiber 200.

In embodiments described herein, the method of drawing the hollow-core optical fiber may satisfy the following Equation 1 to minimize confinement losses in the hollow-core optical fiber:

$${X}_{1} = \frac{{L}_{draw} σ}{{V}_{draw} 2 μ {r}_{cap}} \qquad EQU . 1$$

In Equation 1, L_{draw} is the length of the draw furnace 1102 (as described above), σ is a surface tension of the substrate 230 at a maximum draw furnace temperature (draw temperature), V_{draw} is a draw speed of the hollow-core optical fiber 200, μ is a viscosity of the substrate 230 at the maximum draw furnace temperature (draw temperature), and r_{cap} is a capillary radius of the capillary 220. In embodiments, X₁ may be less than or equal to 0.030, less than or equal to 0.025, less than or equal to 0.018, less than or equal to 0.015, less than or equal to 0.013, less than or equal to 0.010, or less than or equal to 0.005.

Non-dimensional parameter X₁ is the ratio of a characteristic residence time t₁ (L_{draw}/V_{draw}) in the draw furnace 1102 and a characteristic deformation time t₂ (2μr_{cap}/σ). In order to reduce the deformation of the tubes 120 or the nested tubes 150 that results in contact overlap (resulting in the contact lengths L₁ and L₂) between the capillary 220 and nested capillary 250 with the inner surface 232 of the substrate 230, the non-dimensional parameter X₁ (and thus, the characteristic residence time t₁) may be minimized when compared to ordinary characteristic residence times t₁ typically used in high speed, large scale manufacturing.

The method of drawing the hollow-core optical fiber 200 from the hollow-core preform may also satisfy the following Equation 2 to minimize confinement losses in the hollow-core optical fiber:

$${X}_{2} = \frac{{L}_{draw} Δ p}{{V}_{draw} μ} \qquad EQU . 2$$

In Equation 2, Δp is a pressure differential between the capillary 220 and the hollow core 210 of the hollow-core optical fiber 200 during the drawing. In embodiments, X₂ may be greater than or equal to 10⁻¹⁰, greater than or equal to 10⁻⁹, greater than or equal to 10⁻⁸, greater than or equal to 10⁻⁷, greater than or equal to 106, or greater than or equal to 10⁻⁵, greater than or equal to 104, or greater than or equal to 10⁻³.

Non-dimensional parameter X₂ is the ratio of the characteristic residence time t₁ (L_{draw}/V_{draw}) in the draw furnace 1102 and a characteristic capillary expansion time t₃ (μ/Δp), which may be adjusted by changing the pressure differential between the capillary 220 and the hollow core 210 of the hollow-core optical fiber 200. As noted above, the characteristic residence time t₁ may be minimized in order to reduce the contact lengths L₁ and L₂ of between the capillary 220 and the nested capillary 250 with the inner surface 232 of the substrate 230. However, the non-dimensional parameter X₂ (and thus, the characteristic residence time t₁) may also be large enough to allow for capillary 220 and nested capillary 250 expansion to a dimension such that the capillary 220 and nested capillary 250 act effective anti-resonant structures within the hollow-core optical fiber 200. The non-dimensional parameter X₂ may also be increased by minimizing the characteristic capillary expansion time t₃ (μ/Δp).

In embodiments, the hollow-core preform 100 may be drawn at a surface tension σ from 30 g to 400 g to form hollow-core optical fiber 200. For example, without limitation, the hollow-core preform 100 may be drawn at a surface tension σ from 30 g to 400 g, from 50 g to 400 g, from 100 g to 400 g, from 150 g to 400 g, from 200 g to 400 g, from 250 g to 400 g, from 300 g to 400 g, from 350 g to 400 g, from 30 g to 350 g, from 30 g to 300 g, from 30 g to 250 g, from 30 g to 200 g, from 30 g to 150 g, from 30 g to 100 g, from 30 g to 50 g, or any combination or sub-set of these ranges.

In embodiments, the draw furnace 1102 may have a draw furnace length L_{draw} of less than or equal to 30 cm. In other embodiments, the draw furnace 1102 may have a draw furnace length L_{draw} of less than or equal to 25 cm, less than or equal to 20 cm, less than or equal to 15 cm, less than or equal to 12 cm, less than or equal to 10 cm, or even less than or equal to 5 cm.

In embodiments, the draw furnace 1102 may be operated at temperatures of 1700° C. to 2150° C. to draw the hollow-core optical fiber from the hollow-core preform. For example, without limitation, drawing the hollow-core optical fiber 200 (or 201) from the hollow-core preform 100 may occur at a furnace temperature from 1700° C. to 2150° C., from 1700° C. to 2100° C., from 1700° C. to 2050° C., from 1700° C. to 2000° C., from 1700° C. to 1950° C., from 1700° C. to 1900° C., from 1700° C. to 1850° C., from 1700° C. to 1800° C., from 1700° C. to 1750° C., from 1750° C. to 2150° C., from 1800° C. to 2150° C., from 1850° C. to 2150° C., from 1900° C. to 2150° C., from 1950° C. to 2150° C., from 2000° C. to 2150° C., from 2050° C. to 2150° C., from 2100° C. to 2150° C., or any combination or sub-set of these ranges. In embodiments, the furnace temperature is constant along the draw furnace length L_{draw}. In other embodiments, the furnace temperature varies along the draw furnace length L_{draw}. For example, the furnace temperature may be higher near the draw end of the preform than at the end of the preform opposite the draw end. As used herein, “draw temperature” refers to the maximum temperature of the draw furnace during draw of the preform.

In embodiments, hollow-core optical fiber 200 (or 201) may be drawn from the hollow-core preform 100 at a draw speed V_{draw} from 0.10 m/s to 60 m/s. For example, without limitation, hollow-core optical fiber 200 may be drawn from the hollow-core preform 100 at a rate from 0.10 m/s to 60 m/s, from 0.50 m/s to 60 m/s, from 1.00 m/s to 60 m/s, from 5 m/s to 60 m/s, from 10 m/s to 60 m/s, from 20 m/s to 60 m/s, from 30 m/s to 60 m/s, from 40 m/s to 60 m/s, from 50 m/s to 60 m/s, from 0.10 m/s to 50 m/s, from 0.10 m/s to 40 m/s, from 0.10 m/s to 30 m/s, from 0.10 m/s to 20 m/s, from 0.10 m/s to 10 m/s, from 0.10 m/s to 5 m/s, from 0.10 m/s to 1.00 m/s, from 0.10 m/s to 0.50 m/s, or any combination or sub-set of these ranges.

In embodiments the substrate 230 may have a viscosity μ at 1800° C. of from 5×10⁵ Poise to 8×10⁶ Poise. For example, without limitation, the substrate 230 may have a viscosity μ from 1×10⁶ Poise to 7×10⁶ Poise, from 1.5×10⁶ Poise to 6×10⁶ Poise, or any other suitable range of viscosities.

In embodiments the capillary 220 may have a capillary radius r_{cap} from 10 μm to 30 μm. For example, without limitation, the capillary 220 may have a capillary radius r_{cap} from 10 μm to 30 μm, from 12 μm to 28 μm, from 15 μm to 25 μm, from 18 μm to 22 μm, from 15 μm to 30 μm, or from 18 μm to 30 μm.

In embodiments, a pressure of the interior cavity 105 and/or the internal opening 124 of the tubes 120 may be from 600 Pascal (Pa) to 7,000 Pa. For example, without limitation, the pressure may be from −14,000 Pa to 28,000 Pa, from −7,000 Pa to 21,000 Pa, from −3,500 Pa to 14,000 Pa, from 0 Pa to 11,000 Pa, from 689 Pa to 6,895 Pa, from 1,378 Pa to 6,895 Pa, from 2,068 Pa to 6,895 Pa, from 2,757 Pa to 6,895 Pa, from 3,447 Pa to 6,895 Pa, from 4,136 Pa to 6,895 Pa, from 4,826 Pa to 6,895 Pa, from 5,515 Pa to 6,895 Pa, from 6,205 Pa to 6,895 Pa, from 689 Pa to 6,205 Pa, from 689 Pa to 5,515 Pa, from 689 Pa to 4,826 Pa, from 689 Pa to 4,136 Pa, from 689 Pa to 3,447 Pa, from 689 Pa to 2,757 Pa, from 689 Pa to 2,068 Pa, from 689 Pa to 1,378 Pa, or any combination or sub-set of these ranges.

As such, the pressure differential Δp between the capillary 220 and the hollow core 210 of the hollow-core optical fiber 200 (or 201) during the drawing may be from 0 Pa to 13,800 Pa. For example, without limitation, the pressure differential Δp may be from 0 Pa to 2,800 Pa, or from 1,380 Pa to 5,550 Pa.

### EXAMPLES

The embodiments described herein will be further clarified by the following examples.

### Example 1—Effect of Diameter on Contact Length

A hollow-core optical fiber was produced from a hollow-core preform comprising a substrate support structure, an overclad, and six tubes arranged as shown in FIG. 1A. The hollow-core preform was placed in a furnace held at a temperature of 2050° C. to begin the draw process. The hollow core preform was drawn at a draw temperature of 1975° C. The downward feed of the hollow core preform was 3 mm/min and the draw speed of the hollow-core optical fiber was about 30 m/min. Pressure was applied to the internal cavity of the hollow-core preform during the drawing process at 1,725 Pa.

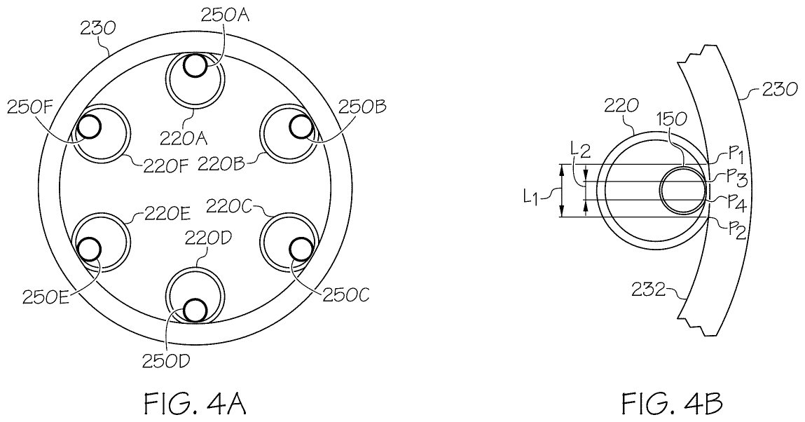

The contact length between the capillaries and the substrate was observed for hollow-core optical fibers drawn from hollow-core preforms of varying cross-sectional areas. As noted herein, a decrease in cross-sectional area of a hollow-core preform results in a shorter contact length between the capillary and the substrate in the resultant hollow-core optical fiber. For example, FIGS. 6A-6C depict a cross-section of a hollow-core optical fiber drawn from a hollow-core preform having a diameter of 41 mm (e.g., 1320 mm² in cross-sectional area), a cross-section of a hollow-core optical fiber drawn from a hollow-core preform having a diameter of 25 mm (e.g., 491 mm² in cross-sectional area), and a cross-section of a hollow-core optical fiber drawn from a hollow-core preform having a diameter of 12.5 mm (e.g., 123 mm² in cross-sectional area), respectively. As depicted in FIGS. 6A, FIG. 6B, and FIG. 6C, the contact length between the capillaries and the substrate becomes shorter as the cross-sectional area of the hollow-core preform decreases, indicating that hollow-core preforms with larger cross-sectional areas may result in hollow-core optical fibers with higher confinement losses.

### Example 2—Effect of Temperature on Contact Length

A hollow-core optical fiber was produced from a hollow-core preform comprising a substrate support structure, an overclad, and six tubes arranged as shown in FIG. 1A. The hollow-core preform was drawn into hollow-core optical fiber at three different draw temperatures: 2025° C., 2000° C., and 1975° C. The diameter of the hollow-core preform was 40 mm (1,257 mm² in cross-sectional area). The downward feed of the hollow-core preform was 3 mm/min and the draw speed of the hollow-core optical fiber was about 20 m/min. Pressure was applied to the internal cavity of the hollow-core preform during the drawing process at 1,725 Pa.

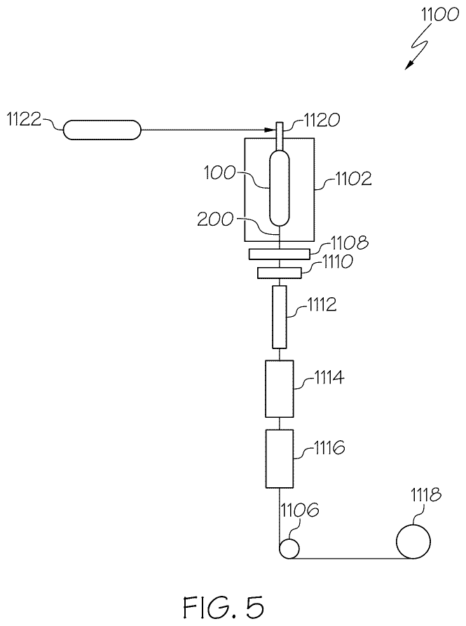

The contact length between the capillaries and the substrate was observed for hollow-core optical fibers drawn from hollow-core preforms at draw temperatures. As noted hereinabove, a decrease in draw temperature results in a shorter contact length between the capillary and the substrate. For example, FIG. 7A depicts a cross-section of a hollow-core optical fiber drawn from a hollow-core preform at a draw temperature of 2025° C., FIG. 7B depicts a cross-section of a hollow-core optical fiber drawn from a hollow-core preform at a draw temperature of 2000° C., and FIG. 7C depicts a cross-section of a hollow-core optical fiber drawn from a hollow-core preform at a draw temperature of 1975° C. As depicted in FIG. 7A, FIG. 7B, and FIG. 7C, the contact length between the capillaries and the substrate becomes shorter as the draw temperature decreases, indicating that lower draw temperatures may result in hollow-core optical fibers with lower confinement losses.

### Example 3—Effect of Draw Speed on Contact Length

A hollow-core optical fiber was produced from a hollow-core preform comprising a substrate support structure, an overclad, and six tubes arranged as shown in FIG. 1A. The hollow-core preform was placed in a furnace held at a temperature of 2025° C. to begin the draw process. The hollow core preform was drawn at a draw temperature of 1975° C. The diameter of the hollow-core preform was 40 mm (1,257 mm² in cross-sectional area). The downward feed of the hollow-core preform was 2.5 mm/min. Pressure was applied to the internal cavity of the hollow-core preform during the drawing process at 1,725 Pa.

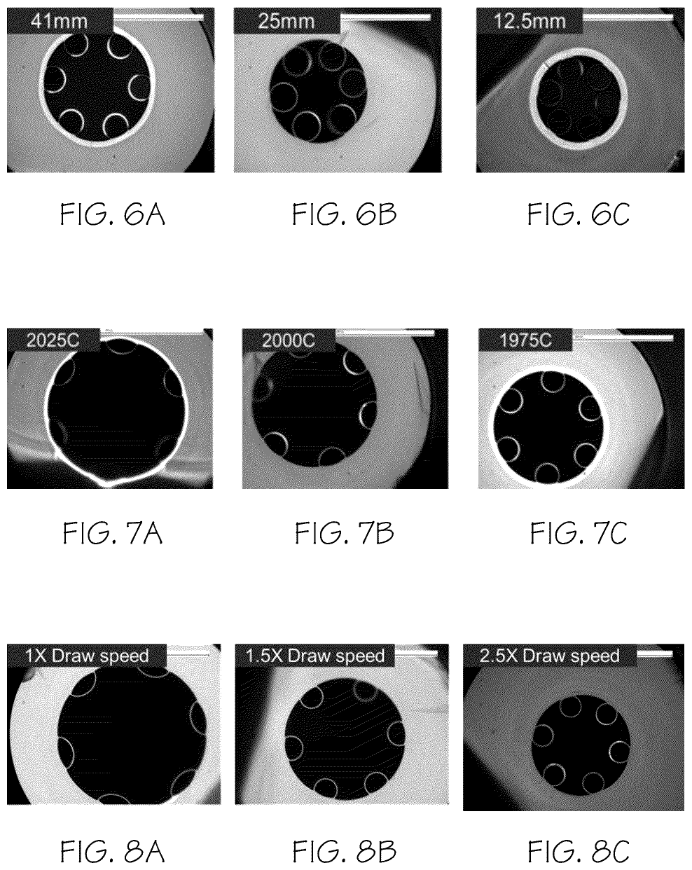

The contact length between the capillaries and the substrate was observed for hollow-core preforms drawn at varying draw speeds. As noted hereinabove, an increase in draw speed results in a shorter contact length between the capillary and the substrate. For example, FIG. 8A depicts a cross-section of a hollow-core optical fiber drawn at a speed of 0.50 m/s; FIG. 8B depicts a cross-section of a hollow-core optical fiber drawn at a speed of 0.75 m/s; and FIG. 8C depicts a cross-section of a hollow-core optical fiber drawn at a speed of 1.25 m/s. As depicted in FIG. 8A, FIG. 8B, and FIG. 8C, the contact length between the capillaries and the substrate becomes shorter as the draw speed increases, indicating that higher draw speeds may result in hollow-core optical fibers with lower confinement losses.

The present disclosure is directed to various embodiments of methods for producing a hollow-core optical fiber. The methods may include heating a hollow-core preform having a cross-sectional area greater than 0.0013 m². The hollow-core preform may comprise a substrate structure with an inner surface defining an interior cavity, the interior cavity comprising a tube in contact with the inner surface of the substrate structure, the tube comprising a wall defining an internal opening. The method may further include drawing the hollow-core optical fiber from the hollow-core preform, the drawing comprising elongating the tube to a capillary and elongating the substrate structure to a substrate, the capillary comprising a capillary outer diameter and a contact length with the inner surface of the substrate. The contact length may be a linear distance from a first contact point of the capillary with the inner surface of the substrate to a second contact point of the capillary with the inner surface of the substrate and the contact length may be less than or equal to 2% of the capillary outer diameter.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for producing a hollow-core optical fiber, the method comprising:
heating a hollow-core preform having a cross-sectional area greater than 0.0013 m², the hollow-core preform comprising a substrate structure with an inner surface defining an interior cavity, the interior cavity comprising a tube in contact with the inner surface of the substrate structure, the tube comprising a wall defining an internal opening; and
drawing the hollow-core optical fiber from the hollow-core preform, the drawing comprising elongating the tube to a capillary and elongating the substrate structure to a substrate, the capillary comprising a capillary outer diameter and a contact length with the inner surface of the substrate, wherein:
the contact length is a linear distance from a first contact point of the capillary with the inner surface of the substrate to a second contact point of the capillary with the inner surface of the substrate; and
the contact length is less than or equal to 20% of the capillary outer diameter.

2. The method of claim 1, wherein the cross-sectional area of the hollow-core preform is greater than 0.0020 m².

3. The method of claim 1, wherein the contact length with the inner surface of the substrate is less than or equal to 5% of the capillary outer diameter.

4. The method of claim 1, wherein the tube comprises a nested tube and the nested tube is in contact with an interior surface of the wall of the tube.

5. The method of claim 4, wherein the drawing further comprises elongating the nested tube to a nested capillary, the nested capillary comprising a nested capillary outer diameter and a nested contact length with the inner surface of the substrate.

6. The method of claim 5, wherein:
the nested contact length is a linear distance from a third contact point of the nested capillary with the inner surface of the substrate to a fourth contact point of the nested capillary with the inner surface of the substrate; and
the nested contact length is less than or equal to 20% of the nested capillary outer diameter.

7. The method of claim 1, wherein the heating further comprises passing the hollow-core preform through a draw furnace, the draw furnace having a maximum draw furnace temperature of less than 2,000° C.

8. The method of claim 7, wherein the draw furnace comprises a draw furnace length of less than or equal to 20 cm.

9. The method of claim 1, further comprising drawing the hollow-core optical fiber from the hollow-core preform at a draw speed of greater than or equal to 1.00 m/s.

10. The method of claim 1, further comprising flowing gas through at least one of the interior cavity, the internal opening, or both the interior cavity and the internal opening.

11. A method for producing a hollow-core optical fiber, the method comprising:
heating a hollow-core preform having a cross-sectional area greater than 0.0013 m², the hollow-core preform comprising a substrate structure with an inner surface defining an interior cavity, the interior cavity comprising a tube in contact with the inner surface of the substrate structure, the tube comprising a wall defining an internal opening; and
drawing the hollow-core optical fiber from the hollow-core preform, the drawing comprising elongating the tube to a capillary and elongating the substrate structure to a substrate, the capillary comprising a capillary outer diameter and a contact length with the inner surface of the substrate, wherein the drawing decreases a core diameter of a hollow core of the hollow-core optical fiber, wherein:
a core distance from the inner surface of the interior cavity to the core diameter of the hollow core is greater than or equal to 90% of the capillary outer diameter; the contact length is a linear distance from a first contact point of the capillary with the inner surface of the substrate to a second contact point of the capillary with the inner surface of the substrate; and
the contact length is less than or equal to 20% of the capillary outer diameter.

12. The method of claim 11, wherein the core distance is greater than or equal to 93% of the capillary outer diameter.

13. The method of claim 11, wherein the tube comprises a nested tube in contact with an interior surface of the wall of the tube.

14. The method of claim 13, wherein the drawing further comprises elongating the nested tube to a nested capillary, the nested capillary comprising a nested capillary outer diameter and a nested contact length with the inner surface of the substrate.

15. The method of claim 14, wherein:
the nested contact length is a linear distance from a third contact point of the nested capillary with the inner surface of the substrate to a fourth contact point of the nested capillary with the inner surface of the substrate; and
the nested contact length is less than or equal to 20% of the nested capillary outer diameter.

16. The method of claim 15, wherein the core distance is from the nested capillary outer diameter to the core diameter of the hollow core.

17. A method for producing a hollow-core optical fiber, the method comprising:
heating a hollow-core preform having a cross-sectional area greater than 0.0013 m², the hollow-core preform comprising a substrate structure with an inner surface defining an interior cavity, the interior cavity comprising a tube in contact with the inner surface of the substrate structure, the tube comprising a wall defining an internal opening;
flowing gas through at least one of the interior cavity, the internal opening, or both the interior cavity and the internal opening; and
drawing the hollow-core optical fiber from the hollow-core preform at a draw temperature, the drawing comprising elongating the tube to a capillary and elongating the substrate structure to a substrate, the capillary comprising a capillary outer diameter and a contact length with the inner surface of the substrate, wherein:
the contact length is a linear distance from a first contact point of the capillary with the inner surface of the substrate to a second contact point of the capillary with the inner surface of the substrate;
the contact length is less than or equal to 20% of the capillary outer diameter; and
the drawing of the hollow-core optical fiber satisfies the following Equation 1:
$${X}_{1} = \frac{{L}_{draw} σ}{{V}_{draw} 2 μ {r}_{cap}} \qquad EQU . 1$$
wherein L_{draw} is a draw furnace length, σ is a surface tension of the substrate at the draw temperature, V_{draw} is a draw speed of the hollow-core optical fiber, μ is a viscosity of the substrate at the draw temperature, and r_{cap} is a capillary radius of the capillary, wherein X₁ is less than or equal to 0.015.

18. The method of claim 17, wherein X₁ is less than or equal to 0.010.

19. The method of claim 17, wherein drawing of the hollow-core optical fiber satisfies the following Equation 2:
$${X}_{2} = \frac{{L}_{draw} Δ p}{{V}_{draw} μ} \qquad EQU . 2$$
wherein Δp is a pressure differential between the capillary and a hollow core of the hollow-core optical fiber during the drawing, wherein X₂ is greater than or equal to 10⁻⁷.

20. The method of claim 19, wherein X₂ is greater than or equal to 10⁻⁵.
